(19) United States
(12) Patent Application Publication
(10) Pub. No.: US 2025/0191794 A1
(43) Pub. Date: Jun. 12, 2025

(54) NUCLEAR POWER GENERATION SYSTEM AND NUCLEAR POWER GENERATION METHOD

(71) Applicant: MITSUBISHI HEAVY INDUSTRIES, LTD., Tokyo (JP)

(72) Inventors: Shota Kobayashi, Tokyo (JP); Satoru Kamohara, Tokyo (JP); Naohiko Seto, Tokyo (JP); Tadakatsu Yodo, Tokyo (JP); Shohei Otsuki, Tokyo (JP); Kentaro Hamano, Tokyo (JP); Yutaka Tanaka, Tokyo (JP); Tatsuo Ishiguro, Tokyo (JP); Hironori Noguchi, Tokyo (JP); Takafumi Noda, Tokyo (JP); Kazuhiro Yoshida, Tokyo (JP)

(73) Assignee: MITSUBISHI HEAVY INDUSTRIES, LTD., Tokyo (JP)

(21) Appl. No.: 18/840,257

(22) PCT Filed: Feb. 15, 2023
(86) PCT No.: PCT/JP2023/005138

§ 371 Date: Aug. 21, 2024

(30) Foreign Application Priority Data
Feb. 25, 2022 (JP) 2022-028117

(51) Int. Cl. G21C 11/02; G21C 15/253

(52) U.S. Cl. CPC G21C 11/024; G21C 15/253

(57) ABSTRACT

A nuclear power generation system capable of generating power with robust shielding against ionizing radiation is provided. This nuclear power generation system includes: a nuclear reactor that includes a core fuel, and a reactor vessel that surrounds to cover the core fuel and to shield a space having the core fuel for shielding against ionizing radiation; a thermal conductor that is disposed inside of the reactor vessel, and transfers heat of the core fuel via solid thermal conduction; a refrigerant circuit that includes a pipe with a part inserted in the reactor vessel and another part disposed outside of the reactor vessel, and through which refrigerant is passed, and that circulates the refrigerant exchanging heat with the thermal conductor; a turbine that is rotated by the refrigerant circulating through the refrigerant circuit; and a generator that is rotated integrally with the turbine.

### FIELD

The present disclosure relates to a nuclear power generation system and a nuclear power generation method.

### BACKGROUND

In a nuclear power generation system that uses a nuclear fuel, and generates power using the heat resultant of nuclear fissions, the heat generated in a nuclear reactor is recovered in a primary cooling system where primary coolant is circulated, between the nuclear reactor and a secondary cooling system. Heat exchange is then carried out between the primary coolant and secondary coolant, and the turbine provided to the secondary cooling system is rotated to generate power using the energy of the secondary coolant.

Patent Literature 1 discloses a power generation system that includes: a nuclear reactor having a core fuel and a reactor vessel that surrounds to cover the core fuel, and that shields from ionizing radiation by providing shielding to a space having the core fuel; and a thermal conductor that is disposed on at least a part of the reactor vessel and that transfers the heat inside of the reactor vessel to outside via solid thermal conduction.

### CITATION LIST

### Patent Literature

Patent Literature 1: Japanese Patent Application Laid-open No. 2020-165836

### SUMMARY

### Technical Problem

In nuclear power generation systems, ionizing radiation is generated in the nuclear reactor. As disclosed in Patent Literature 1, use of the solid thermal conduction can provide more robust shielding against ionizing radiation. There is a demand for nuclear power generation systems using other structures, too, to generate power with such robust shielding against the ionizing radiation.

The present disclosure is to address such a demand, and an object of the present invention is to provide a nuclear power generation system and a nuclear reactor power generation method capable of generating power with such robust shielding against ionizing radiation.

### Solution to Problem

To achieve the above-described object, a nuclear power generation system according to an aspect of the present disclosure includes: a nuclear reactor that includes a core fuel, and a reactor vessel that surrounds to cover the core fuel and to shield a space having the core fuel for shielding against ionizing radiation; a thermal conductor that is disposed inside of the reactor vessel, and transfers heat of the core fuel via solid thermal conduction; a refrigerant circuit that includes a pipe with a part inserted in the reactor vessel and another part disposed outside of the reactor vessel, the pipe through which refrigerant is passed, and that circulates the refrigerant exchanging heat with the thermal conductor; a turbine that is rotated by the refrigerant circulating through the refrigerant circuit; and a generator that is rotated integrally with the turbine.

To achieve the above-described object, a nuclear power generation method according to an aspect of the present disclosure includes: causing a nuclear fission of a core fuel and generating heat, in a nuclear reactor that includes the core fuel, and a reactor vessel that surrounds to cover the core fuel and to shield a space having the core fuel for shielding against ionizing radiation; transferring heat of the core fuel via solid thermal conduction of a thermal conductor disposed inside of the reactor vessel; causing refrigerant to exchange heat with the thermal conductor, and to heat the refrigerant with the heat of the nuclear reactor, using a refrigerant circuit including a pipe that has a part inserted in the reactor vessel and another part disposed outside of the reactor vessel, and through which the refrigerant is passed; and causing the refrigerant circulating through the refrigerant circuit to rotate, wherein the refrigerant is carbon dioxide.

### Advantageous Effects of Invention

According to the present disclosure, it is possible to achieve power generation capability with the robust shielding against ionizing radiation, advantageously.

### BRIEF DESCRIPTION OF DRAWINGS

FIG. 1 is a schematic illustrating a general structure of a nuclear power generation system according to an embodiment.

FIG. 2 is a schematic illustrating a general structure of a nuclear power generation system according to another embodiment.

FIG. 3 is an enlarged sectional view illustrating a sectional structure of a part of a nuclear reactor.

FIG. 4 is a schematic illustrating a structure near the inner wall of a reactor vessel.

FIG. 5 is a schematic illustrating a structure near the inner wall of a reactor vessel according to another example.

FIG. 6 is a schematic illustrating a structure near the inner wall of a reactor vessel according to another example.

FIG. 7 is a schematic illustrating a structure near the inner wall of a reactor vessel according to another example.

FIG. 8 is a schematic illustrating a general structure of a nuclear power generation system according to another embodiment.

### DESCRIPTION OF EMBODIMENTS

Some embodiments according to the present disclosure will now be explained in detail with reference to the drawings. These embodiments are, however, not intended to limit the scope of the present invention in any way. The components described in the following embodiments include those that are replaceable by those skilled in the art or those that are substantially identical.

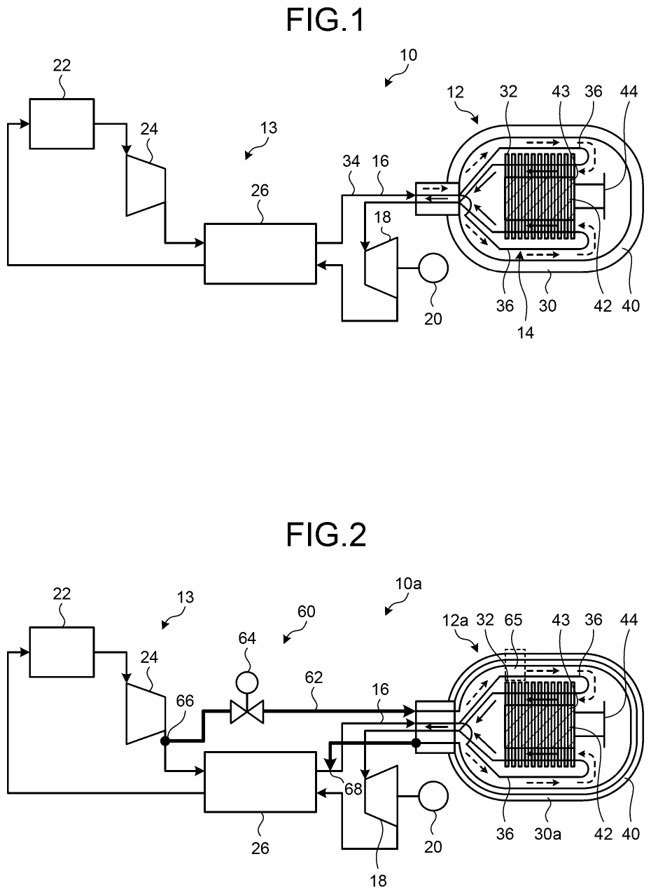

FIG. 1 is a schematic illustrating a general structure of a nuclear power generation system according to an embodiment. As illustrated in FIG. 1, this nuclear power generation system 10 includes a nuclear reactor unit 12 and a generator unit 13. The generator unit 13 includes a heat exchanger 14, a refrigerant circuit 16, a turbine 18, a generator 20, a cooler 22, a compressor 24, and a reheat exchanger 26.

The nuclear reactor unit 12 includes a nuclear reactor 30 and thermal conductors 32. The nuclear reactor 30 includes a reactor vessel 40, a core fuel 42, and a control unit 44. The reactor vessel 40 stores therein the core fuel 42. The reactor vessel 40 stores therein the core fuel 42 in a sealed fashion. The reactor vessel 40 has an opening and closing portion so that the core fuel 42 to be placed in the reactor vessel 40 can be inserted and removed thereto and therefrom. An example of the opening and closing portion includes a lid. The reactor vessel 40 can remain sealed even when nuclear fissions occur inside the reactor vessel 40 and the internal temperature and pressure rises. The reactor vessel 40 is made of a material capable of shielding from neutron beams, and has a thickness not causing any leakage of the neutron beams generated inside the reactor vessel 40 to the outside. The reactor vessel 40 is made of concrete, for example. It is also possible for the material of the reactor vessel 40 to include an element with a robust shielding property, such as boron.

The core fuel 42 includes a plurality of fuel support plates 43. Inside each of the fuel support plates 43, a plurality of nuclear fuels are disposed. The fuel support plates 43 are made of a material that transfers heat generated by the nuclear fuels. For the fuel support plates 43, graphite, silicon carbide, or the like may be used. The core fuel 42 generates reaction heat as a result of nuclear fissions of the nuclear fuels.

The control unit 44 includes shielding members that can be moved into the space between lumps of the core fuel 42. The shielding members are what is called control rods with a function for suppressing nuclear fissions by shielding from the ionizing radiation. The nuclear reactor 30 controls the reaction of the core fuel 42 by causing the control unit 44 to move to adjust the position of the shielding members.

The thermal conductors 32 are disposed inside of the reactor vessel 40, as illustrated in FIG. 1, and is in contact with the fuel support plates 43. The thermal conductors 32 according to this embodiment are a plurality of plate-like members, and are structured such that these plates are stacked alternately with the fuel support plates 43. The thermal conductors 32 are plates having external shapes of which are larger than those of the fuel support plates 43, and project out to a space without the fuel support plates 43. For the thermal conductors 32, materials such as titanium, nickel, copper, graphite, or graphene may be used. For the thermal conductors 32, in order to enable the heat to be conducted more efficiently to these projecting portions, it is preferable to use graphene, by disposing the graphene in an orientation enabling the heat to be conducted efficiently in directions across the plate surface. The thermal conductors 32 conduct heat via solid thermal conduction. In other words, the thermal conductors 32 conduct heat without using any heat medium (fluid). Specifically, the thermal conductors 32 conduct heat generated by the core fuel 42 to the generator unit 13 via solid thermal conduction.

The nuclear reactor unit 12 has the configuration described above, in which the core fuel 42 goes through nuclear fissions inside the nuclear reactor 30, and generates reaction heat. The generated heat is contained inside the reactor vessel 40, and increases the temperature inside the reactor vessel 40. In the nuclear reactor unit 12, part of heat generated in the nuclear reactor 30 is transferred to the thermal conductors 32. The thermal conductors 32 heat the refrigerant flowing through the refrigerant circuit 16 included in the generator unit 13. As the refrigerant, carbon dioxide (CO2) is preferably used.

The refrigerant circuit 16 includes a circulation path 34 circulating outside of the reactor vessel 40, and a heat exchanging portion 36 circulating inside of the reactor vessel 40. The circulation path 34 and the heat exchanging portion 36 together form a closed loop, and circulate. The circulation path 34 is a path for circulating the refrigerant outside the reactor vessel 40, and the turbine 18, the cooler 22, the compressor 24, and the reheat exchanger 26 are connected to the circulation path 34. The heat exchanging portion 36 is inserted into and rests inside the reactor vessel 40. Both ends of the heat exchanging portion 36 are exposed outside of the reactor vessel 40, and are connected to the circulation path 34. The heat exchanging portion 36 is a conduit for circulating the refrigerant, and is in contact with parts of the thermal conductors 32 not in contact with the core fuel 42. In other words, the heat exchanging portion 36 is in contact with the projecting portions of the thermal conductors 32, projecting outside of the core fuel 42. The heat exchanging portion 36 heats the refrigerant by exchanging heat with the thermal conductors 32. In this embodiment, the heat exchanging portion 36 and the thermal conductors 32 serve as the heat exchanger 14.

The refrigerant flowing through the refrigerant circuit 16 is supplied into the heat exchanging portion 36. In the nuclear reactor power generation system 10, the thermal conductors 32 exchange heat with the refrigerant supplied through the refrigerant circuit 16. The heat exchanger according to this embodiment is configured with the thermal conductors 32 and the heat exchanging portion 36 of the refrigerant circuit 16. The heat exchanger recovers the heat from the thermal conductors 32, using the refrigerant flowing through the refrigerant circuit 16. In other words, the refrigerant is heated by the thermal conductors 32. The heat medium heated by the heat exchanging portion 36 flows through the turbine 18, the cooler 22, the compressor 24, and the reheat exchanger 26, in the order listed herein. The refrigerant passed through the reheat exchanger 26 is supplied to the heat exchanging portion 36 again. In the manner described above, the refrigerant is circulated through the refrigerant circuit 16.

The refrigerant passed through the heat exchanger 14 flows into the turbine 18. The turbine 18 is then rotated by the energy of the heated refrigerant. In other words, the turbine 18 absorbs the energy from the refrigerant, by converting the energy of the refrigerant into a rotational energy. The generator 20 is coupled to the turbine 18, and is rotated integrally with the turbine 18. The generator 20 generates power by being rotated with the turbine 18.

The cooler 22 cools the refrigerant passed through the turbine 18. Examples of the cooler 22 include a chiller, and a condenser when the refrigerant is temporarily liquefied. The compressor 24 is a pump that compresses the refrigerant. In the regenerative heat exchanger 26, heat is exchanged between the refrigerant passed through the turbine 18 and the refrigerant passed through the compressor 24. In the regenerative heat exchanger 26, the refrigerant passed through the compressor 24 is heated by the refrigerant passed through the turbine 18. In other words, the regenerative heat exchanger 26 recovers the heat to be removed in the cooler 22, using the refrigerant to be supplied to the nuclear reactor unit 12, by allowing the refrigerant before being cooled by the cooler 22 to exchange heat with the refrigerant after being cooled by the cooler 22.

In the nuclear power generation system 10, the heat generated by the reactions of the nuclear fuels inside the nuclear reactor 12 is transferred to the refrigerant inside the heat exchanging portion 36 via the thermal conductors 32, to heat the refrigerant flowing through the refrigerant circuit 16 using the heat of the thermal conductors 32. In other words, the refrigerant absorbs the heat transferred via the thermal conductors 32. With this, the heat generated in the nuclear reactor 12 is transferred via the solid thermal conduction of the thermal conductors 32, and recovered by the refrigerant. The refrigerant is compressed by the compressor 24, and heated while passing across the thermal conductors 32. The turbine 18 is then rotated by the energy of the compressed and heated refrigerant. The refrigerant is then cooled in the cooler 22 to a reference state, and then supplied to the compressor 24 again.

As described above, the nuclear reactor power generation unit 10 transfers the heat inside the nuclear reactor 30 to the refrigerant that is a medium for rotating the turbine 18, using the thermal conductors 32, which conduct heat via solid thermal conduction.

By using carbon dioxide as the refrigerant, the nuclear reactor power generation unit 10 can inhibit contamination of the refrigerant even when the refrigerant is circulated inside the nuclear reactor 30. In this manner, it is possible to suppress the risk of contaminating the medium for rotating the turbine 18. Furthermore, by providing the thermal conductors 32 that transfer heat via solid thermal conduction, the thermal conductors 32 can achieve shielding from neutron beams.

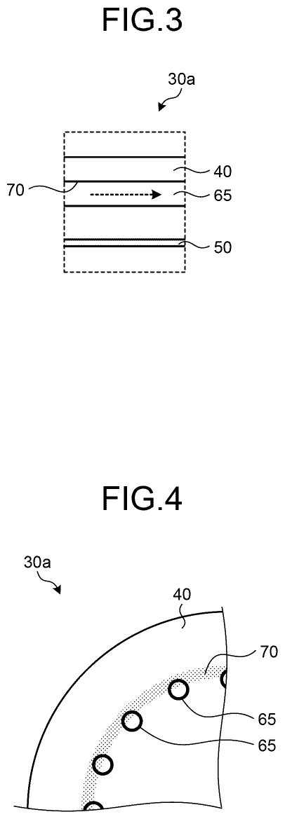

FIG. 2 is a schematic illustrating a general structure of a nuclear power generation system according to another embodiment. FIG. 3 is an enlarged sectional view illustrating a sectional structure of a part of the nuclear reactor. FIG. 4 is a schematic illustrating a structure near the inner wall of the reactor vessel. A nuclear power generation system 10a illustrated in FIG. 2 includes a cooling mechanism 60, in addition to the components included in the nuclear power generation system 10 illustrated in FIG. 1. In the following description, the cooling mechanism 60, which is the component unique to the nuclear power generation system 10a, will be explained, while detailed explanations of the components that are the same as those in the nuclear power generation system 10 will be omitted.

The nuclear power generation system 10a includes a nuclear reactor unit 12a, the generator unit 13, the cooling mechanism 60. In the nuclear reactor unit 12a, a reactor internal pipe 65 that is part of a cooling pipe 62 in the cooling mechanism 60 is disposed inside of a nuclear reactor 30a.

The cooling mechanism 60 includes the cooling pipe (cooling passage) 62 and a control valve 64. The cooling pipe 62 is a pipe having both ends connected to the refrigerant circuit 16, and a part of the cooling pipe 62 rests inside the reactor vessel 40. A part of the cooling pipe 62 disposed inside of the reactor vessel 40 corresponds to the reactor internal pipe 65. The cooling pipe 62 is connected to the refrigerant circuit 16 at a branch point 66 that is downstream of the compressor 24 and upstream of the regenerative heat exchanger 26. The cooling pipe 62 is connected to the refrigerant circuit 16 at a merge point 68 that is downstream of the regenerative heat exchanger 26 and upstream of where the cooling pipe 62 is inserted into the reactor vessel 40 (upstream of the heat exchanging portion 36). The refrigerant branched at the branch point 66 flows into the cooling pipe 62, passes through the reactor internal pipe 65, reaches the merge point 68, and flows into the refrigerant circuit 16.

The reactor internal pipe 65 is split into a plurality of conduits arranged inside the reactor vessel 40, as illustrated in FIGS. 3 and 4. The reactor internal pipe 65 is disposed in such a manner that these conduits are in contact with an inner wall 70 of the reactor vessel. The reactor internal pipe 65 is disposed nearer to the reactor vessel 40 than a pipe 50 of the heat exchanging portion 36. In the example illustrated in FIG. 4, the reactor internal pipes 65 are arranged at given intervals along the circumferential direction.

By providing the cooling mechanism 60 to the nuclear power generation system 10a, and using a configuration in which the refrigerant in the reactor internal pipe 65 (refrigerant after being passed through the compressor 24) passes near the inner wall 70 of the reactor vessel 40, it is possible to suppress an increase in the temperature of the inner wall 70 of the reactor vessel 40. In this manner, the durability of the reactor vessel 40 can be improved, so that the safety of the nuclear power generation system 10a can be enhanced. Furthermore, by using a cooling structure that uses the cooling mechanism 60, the number of alternative materials and structures that can be used for the reactor vessel 40 can be increased.

Furthermore, by cooling with the cooling mechanism 60 that uses refrigerant to recover heat of the nuclear reactor unit 12 used in the generator unit 13, it is possible for the nuclear power generation system 10a to generate power using the heat generated in the nuclear reactor unit 12, so that the power generation efficiency can be improved.

The cooling mechanism 60 according to this embodiment preferably detects the temperature of the reactor vessel, and controls at least one of the opening and closing of the control valve 64, and the degree by which the control valve 64 is opened, based on the detected temperature. Through such control of the control valve 64, for example, it is possible to circulate the refrigerant to the cooling mechanism 60 to cool the reactor vessel 40 when the temperature of the reactor vessel 40 is higher than a certain temperature, while not circulating the refrigerant to the cooling mechanism 60 when the temperature of the reactor vessel 40 is equal to or lower than the certain temperature.

Although the cooling mechanism 60 according to this embodiment is provided with the control valve 64, it is also possible not to provide the control valve 64 so that the refrigerant always passes through the cooling pipe 62 and the reactor internal pipe 65. With this, it is possible to suppress an increase in the temperature of the reactor vessel 40 without performing any control. Furthermore, in such a configuration, it is preferable to set the proportion of the refrigerant to be branched to the cooling mechanism 60 small, e.g., 2% or so, with respect to the entire amount of the refrigerant. The reactor vessel 40 can be cooled by feeding 2% of the entire refrigerant into the cooling mechanism 60.

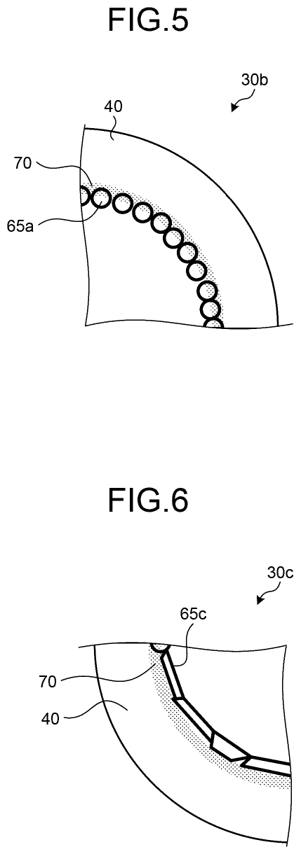

FIG. 5 is a schematic illustrating a structure near the inner wall of a reactor vessel according to another example. In a nuclear reactor 30b illustrated in FIG. 5, reactor internal pipes 65a are arranged in contact with one another. With this, the entire surface of the inner wall 70 is covered with the reactor internal pipes 65a, so that it is possible to further suppress the increase in the temperature of the inner wall 70 of the reactor vessel 40.

FIG. 6 is a schematic illustrating a structure near the inner wall of a reactor vessel according to another example. In a nuclear reactor 30c illustrated in FIG. 6, each reactor internal pipe 65c has a trapezoidal cross section, and adjacent surfaces of the reactor internal pipes 65c are at different positions with respect to the center of the reactor vessel 30c. With this, the entire surface of the inner wall 70 is covered with the reactor internal pipes 65c, so that it is possible to further suppress the increase in the temperature of the inner wall 70 of the reactor vessel 40.

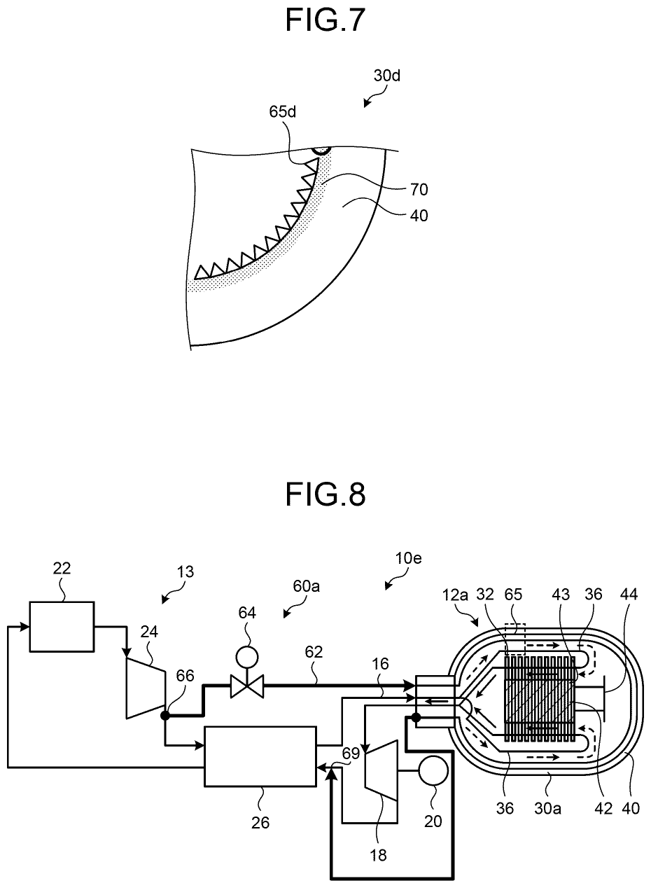

FIG. 7 is a schematic illustrating a structure near the inner wall of a reactor vessel according to another example. In the nuclear reactor 30b illustrated in 5, the reactor internal pipes 65a are arranged in contact with one another. In a nuclear reactor 30d illustrated in FIG. 7, each reactor internal pipe 65d has a triangular cross section, and both ends of the side that is in contact with the inner wall 70 are positioned overlapping with those of the reactor internal pipes 65d adjacent thereto. With this, the entire surface of the inner wall 70 is covered with the reactor internal pipes 65d, so that it is possible to further sup

As illustrated in FIGS. 5 to 7, the shape of the reactor internal pipe may be set to various shapes, e.g., to a circular shape, a true-circular shape, an elliptical shape, and a polygonal shape (e.g., a triangular shape and a rectangular shape). Furthermore, by using a structure in which the adjacent reactor internal pipes are held in contact or disposed overlapping with each other, it is possible to further suppress an increase in the temperature of the inner wall 70.

Furthermore, in the structure according this embodiment, the reactor internal pipes are in contact with the inner wall 70 of the reactor vessel 40; however, the present disclosure is not limited thereto. The reactor internal pipes may also be inserted into the reactor vessel 40. In other words, by cooling the reactor vessel 40 with the reactor internal pipes, an increase in the temperature of the inner wall 70 of the reactor vessel 40 may be suppressed.

FIG. 8 is a schematic illustrating a general structure of a nuclear power generation system according to another embodiment. In this nuclear power generation system 10e illustrated in FIG. 8, a merge point 69 of the cooling pipe 62 in a cooling mechanism 60a is the refrigerant circuit 16 at a position downstream of the turbine 18 and upstream of the reheat exchanger 26.

In the cooling mechanism 60a, by setting the merge point 69 downstream of the turbine 18, the difference in the pressures of the refrigerant at the branch point 66 and that at the merge point 69 is increased, so that the flow rate of the reactor internal pipe 65 can be increased. With this, it is possible to reduce the temperature of the inner wall 70 of the reactor vessel 40 more efficiently.

In the cooling mechanism 60a, because the refrigerant is merged after passing through the turbine 18, the recovered energy cannot be used in power generation. For this reason, it is preferable to cause the cooling mechanism 60a to operate at the time of emergency or abnormality when the temperature of the inner wall of the reactor vessel 40 reaches a certain temperature or higher.

Furthermore, the cooling mechanism may be configured to change the position at which the refrigerant is merged, by being provided with pipes that are connected to the merge point 68 and the merge point 69, respectively, with each of such pipes provided with a control valve.

Furthermore, the positions of the branch point and the merge point in the cooling mechanism are not limited to the examples described in the embodiments. The branch point may be set to any position downstream of the compressor 24 and upstream of the heat exchanging portion 32. The merge point may be set to any position downstream of the branch point and upstream of the compressor 24 (or upstream of the cooler 22, when the cooler 22 is provided). For example, in a configuration in which the regenerative heat exchanger 26 is installed in two stages, the branch point and the merge point may be provided between the regenerative heat exchanger on the upstream side and the regenerative heat exchanger on the downstream side.

### REFERENCE SIGNS LIST

10 Nuclear power generation system
12 Nuclear reactor unit
13 Generator unit
14 Heat exchanger
16 Refrigerant circuit
18 Turbine
20 Generator
22 Chiller (cooler)
24 Pump (compressor)
26 Regenerative heat exchanger
30 Nuclear reactor
32 Thermal conductor
34 Circulation path
36 Heat exchanging portion
40 Reactor vessel
42 Core fuel
43 Fuel support plate
44 Control unit
60 Cooling mechanism
62 Cooling pipe
64 Control valve
65 Reactor internal pipe
66 Branch point
68, 69 Merge point

1. A nuclear power generation system comprising:
a nuclear reactor that includes a core fuel, and a reactor vessel that surrounds to cover the core fuel and to shield a space having the core fuel for shielding against ionizing radiation;
a thermal conductor that is disposed inside of the reactor vessel, and transfers heat of the core fuel via solid thermal conduction;
a refrigerant circuit that includes a pipe with a part inserted in the reactor vessel and another part disposed outside of the reactor vessel, the pipe through which refrigerant is passed, and that circulates the refrigerant exchanging heat with the thermal conductor;
a turbine that is rotated by the refrigerant circulating through the refrigerant circuit; and
a generator that is rotated integrally with the turbine.

2. The nuclear power generation system according to claim 1, wherein the refrigerant is carbon dioxide.

3. The nuclear power generation system according to claim 1, further comprising:
a compressor that is disposed in the refrigerant circuit and compresses the refrigerant passed through the turbine; and
a cooling mechanism that includes a cooling pipe branched from the refrigerant circuit at a branch point downstream of the compressor and upstream of the thermal conductor, cooling an inner wall of the reactor vessel inside of the reactor vessel, and merged with the refrigerant circuit at a merge point downstream of the branch point.

4. The nuclear power generation system according to claim 3, wherein the cooling pipe has a path in which the merge point with the refrigerant circuit is positioned upstream of the heat exchanger.

5. The nuclear power generation system according to claim 3, wherein the merge point where the cooling pipe is merged with the refrigerant circuit is positioned downstream of the turbine.

6. The nuclear power generation system according to claim 3, further comprising:
a cooler that is disposed in the refrigerant circuit at a position downstream of the turbine and upstream of the compressor, and cools refrigerant; and
a reheat exchanger that exchanges heat between refrigerant in the refrigerant circuit downstream of the compressor and upstream of the thermal conductor and refrigerant in the refrigerant circuit downstream of the turbine and upstream of the cooler, wherein
the branch point where the cooling pipe is branched from the refrigerant circuit is positioned between the compressor and the reheat exchanger.

7. The nuclear power generation system according to claim 3, wherein the cooling pipe has a cross section having any one of a true-circular shape, an elliptical shape, and a polygonal shape.

8. The nuclear power generation system according to claim 3, wherein the cooling pipe is in contact with the inner wall of the reactor vessel.

9. The nuclear power generation system according to claim 3, wherein the cooling pipe is inserted into the reactor vessel.

10. The nuclear power generation system according to claim 3, wherein the cooling mechanism includes a flow regulator valve provided to the cooling pipe.

11. A nuclear power generation method comprising:
causing a nuclear fission of a core fuel and generating heat, in a nuclear reactor that includes the core fuel, and a reactor vessel that surrounds to cover the core fuel and to shield a space having the core fuel for shielding against ionizing radiation;
transferring heat of the core fuel via solid thermal conduction of a thermal conductor disposed inside of the reactor vessel;
causing refrigerant to exchange heat with the thermal conductor, and to heat the refrigerant with the heat of the nuclear reactor, using a refrigerant circuit including a pipe that has a part inserted in the reactor vessel and another part disposed outside of the reactor vessel, and through which the refrigerant is passed; and
causing the refrigerant circulating through the refrigerant circuit to rotate, wherein the refrigerant is carbon dioxide.
